(19) United States
(12) Patent Application Publication
(10) Pub. No.: US 2015/0089271 A1
(43) Pub. Date: Mar. 26, 2015

(54) MANAGEMENT DEVICE, DATA ACQUISITION METHOD, AND RECORDING MEDIUM

(71) Applicant: FUJITSU LIMITED, Kawasaki-shi (JP)

(72) Inventor: Takeru SHIMIZU, Yokohama (JP)

(73) Assignee: FUJITSU LIMITED, Kawasaki-shi (JP)

(21) Appl. No.: 14/554,773

(22) Filed: Nov. 26, 2014

Related U.S. Application Data
(63) Continuation of application No. PCT/JP2012/066434, filed on Jun. 27, 2012.

(51) Int. Cl. G06F 11/20; H04L 29/12

(52) U.S. Cl. CPC G06F 11/2002; H04L 61/15
USPC 714/4.1

(57) ABSTRACT

A management device includes a processor that executes a process. The process includes: saving a conversion table when an information processing apparatus that performs a memory access by the conversion table, in which an active absolute address that is used by the processor to specify data is associated with an active physical address that indicates a storage area in a memory that stores therein the data, has failed; creating a second conversion table in which a standby absolute address that is different from the active absolute address is associated with the active physical address used at the time of a failure and a standby physical address that is different from the active physical address used at the time of the failure is associated with the active absolute address; setting the second conversion table; and acquiring the data from the storage area that is indicated by the physical address.

### CROSS-REFERENCE TO RELATED APPLICATION

This application is a continuation of International Application No. PCT/JP2012/066434, filed on Jun. 27, 2012 and designating the U.S., the entire contents of which are incorporated herein by reference.

### FIELD

The embodiments discussed herein are related to a management device, a data acquisition method, and a data acquisition program.

### BACKGROUND

There is a known related technology that collects logs in order to analyze the cause of a failure when a failure occurs in an information processing system. Namely, there is a known related technology that dumps, when a failure occurs in a system, data that is stored in a system and that is used when the failure has occurred into another storage device or the like.

For example, when the information processing system performs a reboot process on the entirety of the information processing system due to the occurrence of a failure, the information processing system executes the dumping process on the data stored in the memory and then clears a physical memory area that is indicated by all physical addresses. Then, by using the cleared physical memory area, the information processing system performs the reboot process on an operating system (OS).
Patent Document 1: Japanese Laid-open Patent Publication No. 63-132321
Patent Document 2: Japanese Laid-open Patent Publication No. 01-156836
Patent Document 3: Japanese Laid-open Patent Publication No. 2006-072931
Patent Document 4: Japanese Laid-open Patent Publication No. 02-178861

However, with the technology described above that reboots the OS after the dumping process described above, the OS is not able to be rebooted during the dumping process; therefore, there is a problem in that it takes a long time to reboot the information processing system.

Furthermore, in order to promptly reboot the information processing system, it is conceivable to use a technology in which an active system memory and a standby-system memory are arranged; the memory that is to be used is switched from an active-system memory to a standby-system memory when a failure occurs and is then rebooted; and data is dumped from the active-system memory. However, with the technology that switches memories that are to be used when a failure occurs, memories to be used are switched from a standby-system memory to an active-system memory in order to dump data from the active-system memory; therefore, a memory access performed by the information processing system after the reboot is prevented.

### SUMMARY

According to an aspect of the embodiments, a management device includes a processor that executes a process including: saving a conversion table when an information processing apparatus that performs a memory access by using the conversion table, in which an active absolute address that is used by the processor to specify data is associated with an active physical address that indicates a storage area in a memory that stores therein the data, has failed; creating, by using the conversion table saved at the saving, a second conversion table in which a standby absolute address that is different from the active absolute address is associated with the active physical address used at the time of a failure and a standby physical address that is different from the active physical address used at the time of the failure is associated with the active absolute address; setting, in the information processing apparatus, the second conversion table created at the creating; and acquiring, by using the second conversion table that is set at the setting, the data from the storage area that is indicated by the physical address associated with the standby absolute address.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an information processing apparatus according to a first embodiment;

FIG. 2 is a schematic diagram illustrating the functional configuration of a management program according to the first embodiment;

FIG. 3 is a schematic diagram illustrating a system absolute address space that is set by a related information processing apparatus;

FIG. 4 is a schematic diagram illustrating a system absolute address space that is set by the information processing apparatus according to the first embodiment;

FIG. 5 is a schematic diagram illustrating an example of a mapping table;

FIG. 6 is a schematic diagram illustrating a system absolute address space that is set when a main body device has failed;

FIG. 7 is a schematic diagram illustrating an example of a mapping table that is set by a management device when the main body device failed;

FIG. 8 is a schematic diagram illustrating an example of physical memory reset information that is set by the management device when the main body device has failed;

FIG. 9 is a schematic diagram illustrating physical memory reset information that is set by the management device when the main body device has failed again;

FIG. 10 is a schematic diagram illustrating the flow of a process of creating a new mapping table;

FIG. 11 is a flowchart illustrating the flow of a process performed by the information processing apparatus according to the first embodiment; and

FIG. 12 is a schematic diagram illustrating an example of a computer that executes a data acquisition program.

### DESCRIPTION OF EMBODIMENTS

Preferred embodiments will be explained with reference to accompanying drawings.

### [a] First Embodiment

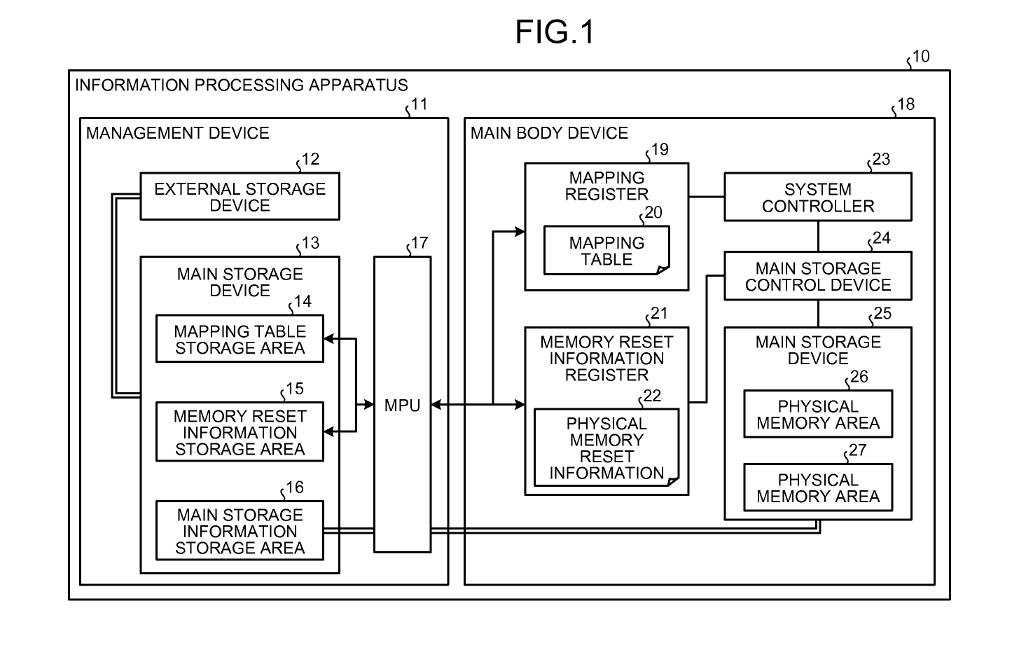

In a first embodiment described below, an example of an information processing apparatus that includes a management device and a main body device will be described with reference to FIG. 1. FIG. 1 is a schematic diagram illustrating an information processing apparatus according to a first embodiment. Furthermore, the information processing apparatus that is illustrated in FIG. 1 as an example is an information processing apparatus that includes at least a processor that executes a program and a main storage device, such as a memory, that stores therein data that is used by the processor.

As illustrated in FIG. 1, an information processing apparatus 10 includes a management device 11 and a main body device 18. Furthermore, the management device 11 includes an external storage device 12, a main storage device 13, and a micro processing unit (MPU) 17. Furthermore, the main storage device 13 includes a mapping table storage area 14, a memory reset information storage area 15, and a main storage information storage area 16.

Furthermore, the main body device 18 includes a mapping register 19, a memory reset information register 21, a system controller 23, a main storage control device 24, and a main storage device 25. Furthermore, the mapping register 19 stores therein a mapping table 20. Furthermore, the memory reset information register 21 stores therein physical memory reset information 22.

Furthermore, the main storage device 25 includes a physical memory area 26 and a physical memory area 27. Although not illustrated in FIG. 1, it is assumed that the main body device 18 includes an OS, the processor, such as a central processing unit (CPU), that executes various programs, and a device that performs various functions.

In the following, first, a description will be given of a function performed by each of the management device 11 and the main body device 18. The main body device 18 is a device that has a function of executing an OS, a hypervisor (HPV), an application, or the like and is, for example, a mainframe device. Specifically, the mapping register 19 is a register that stores therein the mapping table 20 in which a system absolute address that is used by the processor to specify data is associated with a physical address that indicates a storage area of the main storage device 25.

The memory reset information register 21 is a register that stores therein the physical memory reset information 22 that indicates a storage area of the main storage device 25 and that is cleared when the main body device 18 is rebooted. Namely, the memory reset information register 21 is a register that indicates a storage area of the main storage device 25 used after the reboot.

The system controller 23 is a control device that controls the main body device 18 and that controls a memory access performed by an OS or an application that is executed by the main body device 18. Specifically, when a memory access request is issued by an OS or an application, the system controller 23 acquires, from the mapping table 20, a physical address that is associated with an absolute address that is included in the memory access request. Then, the system controller 23 outputs, to the main storage control device 24, the acquired physical address that is associated with the memory access request.

The main storage control device 24 is a control device that executes a memory access that is associated with the main storage device 25 and is, for example, a memory access controller (MAC). For example, when the main storage control device 24 receives a memory access request from the system controller 23, the main storage control device 24 performs a process of reading or writing data from and to the physical address that is included in the received memory access request.

Furthermore, when the main body device 18 is booted up, the main storage control device 24 acquires the physical memory reset information 22 from the memory reset information register 21 and then resets the physical memory area indicated by the acquired physical memory reset information 22. For example, if the physical memory reset information 22 indicates the physical memory area 26, the main storage control device 24 resets the physical memory area 26 when the main body device 18 is booted up. Furthermore, if the physical memory reset information 22 indicates the physical memory area 27, the main storage control device 24 resets the physical memory area 27 when the main body device 18 is booted up.

The main storage device 25 is a storage device that stores therein data that is used when the main body device 18 executes an OS or an application and is, for example, a memory. Specifically, the main storage device 25 includes a plurality of storage areas specified by physical addresses. Furthermore, the main storage device 25 includes a plurality of physical memory areas that includes a plurality of storage areas and manages the areas for each physical memory area. For example, the main storage device 25 includes the physical memory area 26 and the physical memory area 27, uses the physical memory area 26 as an active physical memory area, and uses the physical memory area 27 as a standby physical memory area.

Furthermore, the OS or the application executed by the main body device 18 issues a memory access request by using a system absolute address that corresponds to a part of system absolute address space that is defined by all of the system absolute addresses that are possible to set. Specifically, in the information processing apparatus 10, the number of the system absolute addresses is prepared by the same number as that of all of the physical addresses indicating the storage area included in the main storage device 25. At this point, the OS or the application executed by the main body device 18 issues a memory access request by using only the lower half of all of the system absolute addresses.

Furthermore, when the storage area is requested to be added by the OS or the application, the system controller 23 performs the following process. Namely, from among active system absolute addresses, the system controller 23 distinguishes a system absolute address that is not associated with a physical address from a physical address in the storage area that is added. Then, the system controller 23 associates the distinguished system absolute address with the physical address and then adds the associated addresses in the mapping table 20 that is stored in the mapping register 19.

In contrast, the management device 11 creates the mapping table 20 in which an active system absolute address is associated with a physical address. For example, from among the system absolute addresses the number of which is the same as all of the physical addresses that are stored in the main storage device 25 in the main body device 18, the management device 11 identifies the lower half of all of the system absolute addresses as the active system absolute addresses and identifies the upper half of all of the system absolute addresses as the standby system absolute addresses.

Then, the management device 11 creates the mapping table 20 in which an active system absolute address is associated with a physical address that is stored in the physical memory area 26 in the main storage device 25. Namely, the management device 11 creates the mapping table 20 in which an active system absolute address is associated with an active physical address. Then, the management device 11 stores the mapping table 20 in the mapping register 19 in the main body device 18.

Furthermore, the management device 11 stores, in the memory reset information register 21, the physical memory reset information 22 that indicates a physical address that is associated with an active system absolute address. Then, the management device 11 boots up the main body device 18. By doing so, the main body device 18 clears the physical memory area 26 and boots up the OS or executes the application by using the physical memory area 26.

The management device 11 does not need to create the mapping table 20 in which all of the active system absolute addresses are associated with the physical addresses. For example, the management device 11 only needs to create the mapping table 20 in which the system absolute addresses needed to boot up the main body device 18, such as needed to boot up the OS or the like, are associated with the physical addresses.

At this point, if the main body device 18 has failed and the management device 11 reboots the main body device 18, the management device 11 saves the mapping table 20 from the main body device 18. Then, the management device 11 performs the following process and creates the new mapping table 20.

First, the management device 11 associates standby system absolute addresses with the physical addresses that are associated with the active system absolute addresses in the saved mapping table 20. Namely, the management device 11 associates the storage area that is used when the main body device 18 has failed with a standby system absolute address space.

Furthermore, the management device 11 associates new physical addresses with the active system absolute addresses that are stored in the saved mapping table 20. For example, the management device 11 associates the physical addresses that are stored in the physical memory area 27 with the active system absolute addresses. Namely, the management device 11 associates a storage area that was not used when the main body device 18 failed with an active system address space that was used when the main body device 18 failed. Then, the management device 11 sets the new mapping table 20 in the main body device 18 and reboots the main body device 18.

Then, the main body device 18 reboot itself by using the new mapping table 20. At this point, the active system address space used by the main body device 18 is associated with the storage area that was not used when the main body device 18 failed. Consequently, the main body device 18 can reboot itself without data being cleared that was used when a failure occurred.

Then, the management device 11 acquires data from the storage area that is associated with the standby system address space. At this point, the standby system address space is associated with the storage area that was used when the main body device 18 failed. Consequently, the management device 11 can perform a dumping process on the data that was used when the main body device 18 failed without rewriting the mapping table 20 after the main body device 18 is rebooted.

In the following, a description will be given of the functions performed by the external storage device 12, the main storage device 13, and the MPU 17 included in the management device 11. The external storage device 12 is a storing unit that stores therein various data acquired by the management device 11. For example, the management device 11 stores, in the external storage device 12, a log of the main body device 18, data dumped from the main body device 18.

The main storage device 13 is a memory that includes the mapping table storage area 14, the memory reset information storage area 15, and the main storage information storage area 16. The mapping table storage area 14 mentioned here is a storage area that stores therein the mapping table 20 that is used by the main body device 18 when a memory access is performed.

The memory reset information storage area 15 mentioned here is a storage area that stores therein the physical memory reset information 22 that indicates which one of the physical memory area 26 and the physical memory area 27 is cleared when the main body device 18 is rebooted. Furthermore, the main storage information storage area 16 mentioned here is a storage area that stores therein data that is dumped from the storage area that was used when the main body device 18 failed.

The MPU 17 executes a management program and controls the main body device 18 by using each piece of data stored in the mapping table storage area 14, the memory reset information storage area 15, and the main storage information storage area 16 in the main storage device 13. In the following, a description will be given of the management program executed by the MPU 17.

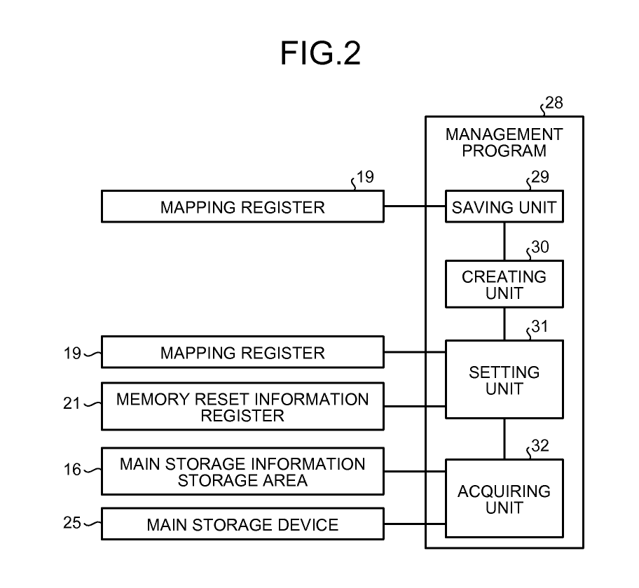

FIG. 2 is a schematic diagram illustrating the functional configuration of a management program according to the first embodiment. As illustrated in FIG. 2, a management program 28 includes a saving unit 29, a creating unit 30, a setting unit 31, and an acquiring unit 32. When the main body device 18 has failed, the saving unit 29 saves the mapping table 20 from the mapping register 19. Then, the saving unit 29 outputs the saved mapping table 20 to the creating unit 30.

The creating unit 30 associates an unused new physical address with an active system absolute address stored in the saved mapping table 20 or with the active system absolute address that is added by the OS or the application executed by the main body device 18. For example, if the physical address that indicates the physical memory area 26 was associated with the active system absolute address in the saved mapping table 20, the creating unit 30 associates a physical address that indicates the physical memory area 27 with an active system absolute address.

Furthermore, the creating unit 30 associates a standby system absolute address with a physical address that is associated with an active system absolute address. Then, the creating unit 30 creates the mapping table 20 that stores therein the newly associated system absolute address and the physical address and then outputs the created mapping table 20 to the setting unit 31.

The setting unit 31 stores the mapping table 20 created by the creating unit 30 in the mapping register 19. Furthermore, the setting unit 31 identifies, the physical address that is associated with the active system absolute address and that is stored in the mapping table 20 created by the creating unit 30. Then, the setting unit 31 creates the physical memory reset information 22 that indicates the identified physical address and stores the created physical memory reset information 22 in the memory reset information register 21.

Furthermore, when the main body device 18 is booted up first, the setting unit 31 stores, in the mapping register 19, the mapping table 20 that is stored in the mapping table storage area 14 of the main storage device 13. Furthermore, when the main body device 18 is booted up first, the setting unit 31 stores, in the memory reset information register 21, the physical memory reset information 22 that is stored in the memory reset information storage area 15. Furthermore, the setting unit 31 stores, in the mapping table storage area 14 or the memory reset information storage area 15, the mapping table 20 or the physical memory reset information 22 that are set in the main body device 18.

Then, the setting unit 31 reboots the main body device 18. For example, the setting unit 31 may reboot the main body device 18 by using an arbitrary method, such as a method of remotely sending an instruction to reboot the main body device 18 or the like. Then, the setting unit 31 issues an execution request for a dumping process to the acquiring unit 32.

When the main body device 18 is rebooted, the acquiring unit 32 dumps data from the storage area that was used when the main body device 18 failed. Specifically, when the acquiring unit 32 receives an execution request for the dumping process from the setting unit 31, the acquiring unit 32 browses the mapping table 20 that is stored in the mapping table storage area 14 in the main storage device 13 and then identifies the physical address that is associated with the standby system absolute address. Namely, the acquiring unit 32 identifies the storage area that was used when the main body device 18 failed.

Then, the acquiring unit 32 performs a memory access on the main storage device 25 and acquires data from the identified storage area. Then, the acquiring unit 32 stores the acquired data in the main storage information storage area 16 and then stores the acquired data in the external storage device 12. For example, if the creating unit 30 used the physical memory area 26 when the main body device 18 has failed, the creating unit 30 associates a physical address in the physical memory area 26 with a standby system absolute address. Consequently, the acquiring unit 32 dumps the data from the physical memory area 26 after the main body device 18 is rebooted.

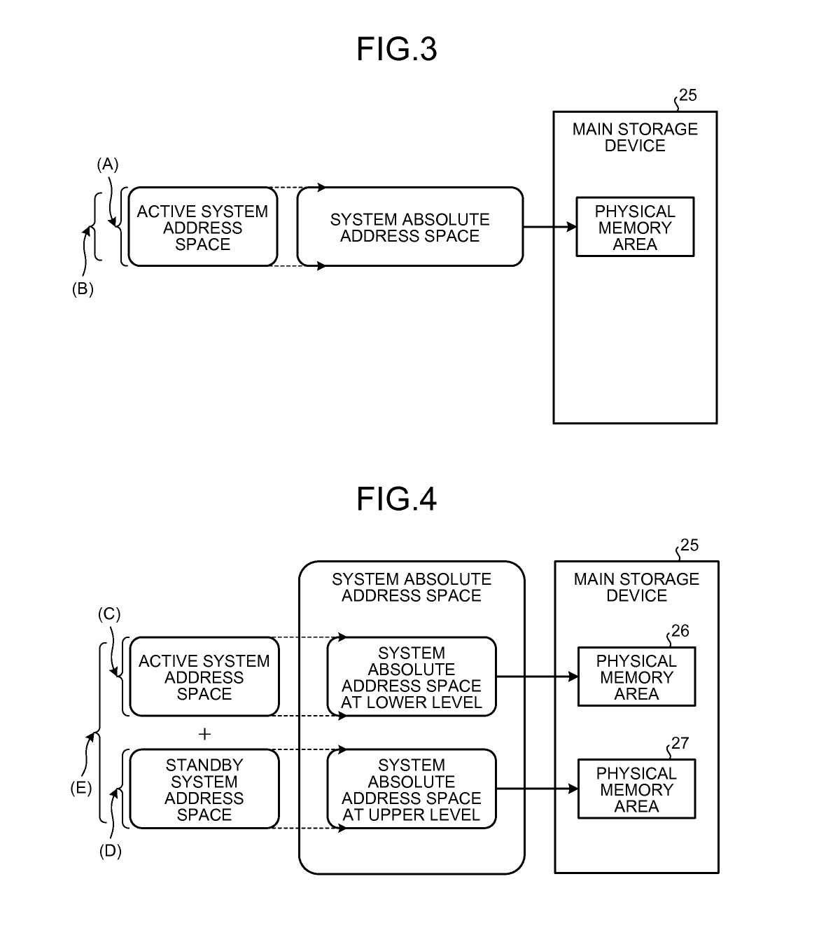

In the following, the relationship between the physical memory areas 26 and 27 and a system absolute address space that is set by the management device 11 and the main body device 18 will be described with reference to FIGS. 3 to 9. First, the relationship between the system absolute address space and the physical memory area that are set by a related information processing apparatus will be described with reference to FIG. 3.

FIG. 3 is a schematic diagram illustrating a system absolute address space that is set by a related information processing apparatus. For example, as illustrated in FIG. 3, the information processing apparatus defines the entirety of the system absolute address space as an active system address space and associates the entirety of the system absolute address space with a single physical memory area. Consequently, as indicated by (A) illustrated in FIG. 3, the main body device included in the related information processing apparatus defines the entirety of the system absolute address space as the active system address space. Furthermore, as indicated by (B) illustrated in FIG. 3, the management device included in the related information processing apparatus defines the entirety of the system absolute address space as the active system address space.

Consequently, for example, if a new physical memory area is set, the related information processing apparatus sets a mapping table in which an active system address space is associated with a new physical memory area. However, when the related information processing apparatus dumps the data stored in the original physical memory area, the related information processing apparatus recreates, when accessing the original physical memory area, a mapping table in which the active system address space is associated with the original physical memory area. Consequently, when the related information processing apparatus performs the dumping process after rebooting the main body device, a memory access performed by the main body device after the rebooting is prevented.

FIG. 4 is a schematic diagram illustrating a system absolute address space that is set by the information processing apparatus according to the first embodiment. For example, the information processing apparatus 10 defines the system absolute address space at the lower level of the system absolute address space as an active system address space and defines the system absolute address space at the upper level of the system absolute address space as a standby system address space. Furthermore, the information processing apparatus 10 associates the system absolute address space at the lower level with physical addresses that indicate the physical memory area 26 and associates the system absolute address space at the upper level with physical addresses that indicate the physical memory area 27.

At this point, the main body device 18 performs a process by using the active system address space indicated by (C) illustrated in FIG. 4. Consequently, the main body device 18 performs the process by using only the physical memory area 26 and does not access the physical memory area 27 that is associated with the standby system address space indicated by (D) illustrated in FIG. 4. In contrast, as indicated by (E) illustrated in FIG. 4, the management device 11 can distinguish the active system address space from the standby system address space.

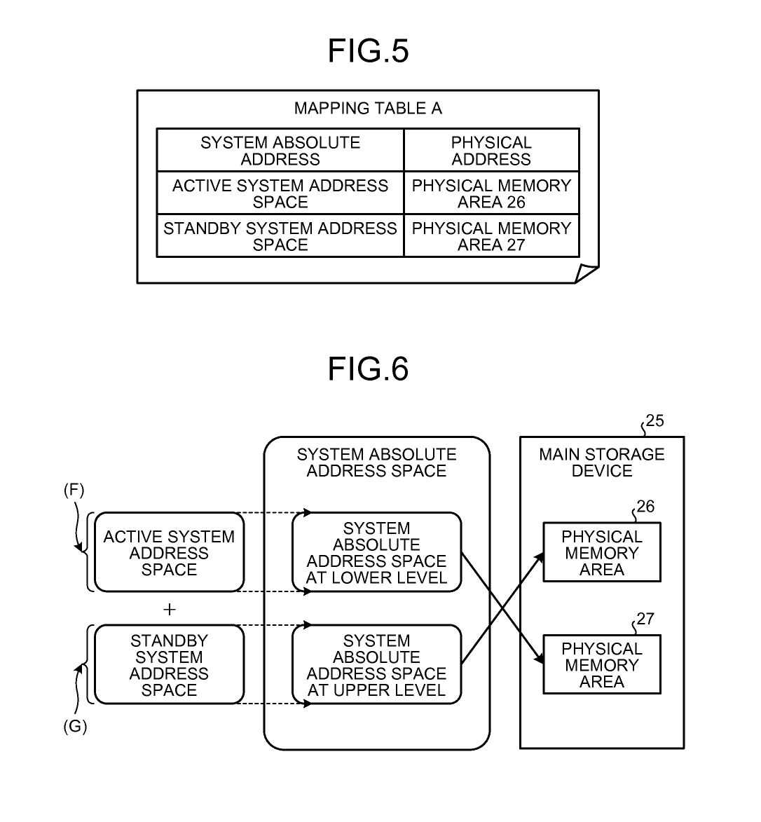

FIG. 5 is a schematic diagram illustrating an example of a mapping table. Furthermore, FIG. 5 illustrates an example of the mapping table 20 that is set by the management device 11 when the address space is defined as illustrated in FIG. 4. For example, if the address space is defined as illustrated in FIG. 4, the management device 11 sets, in the main body device 18, a mapping table A that is illustrated in FIG. 5 as an example.

Specifically, as illustrated in FIG. 5, the mapping table A stores therein, in an associated manner, the absolute addresses that indicate the active system address space and the physical addresses that indicate the physical memory area 26. Furthermore, the mapping table A stores therein, in an associated manner, the absolute addresses in the standby system address space and the physical addresses in the physical memory area 27. At this point, because the main body device 18 identifies only the active system address space, the main body device 18 performs the process by using only the physical memory area 26.

FIG. 6 is a schematic diagram illustrating a system absolute address space that is set when a main body device has failed. As illustrated in FIG. 6, when the main body device 18 has failed, the management device 11 swaps the active system address space with the physical memory area that was associated with the standby system address space.

Specifically, when the main body device 18 fails, the management device 11 saves the mapping table A illustrated in FIG. 5 from the main body device 18. Then, the management device 11 creates a mapping table in which the system absolute address space at the lower level is associated with the physical memory area 27 and the system absolute address space at the upper level is associated with the physical memory area 26.

Namely, as indicated by (F) illustrated in FIG. 6, the management device 11 associates the physical memory area 27 with the active system address space that is identified by the main body device 18. Furthermore, as indicated by (G) illustrated in FIG. 6, the management device 11 associates the physical memory area 26 with the standby system address space that is not identified by the main body device 18.

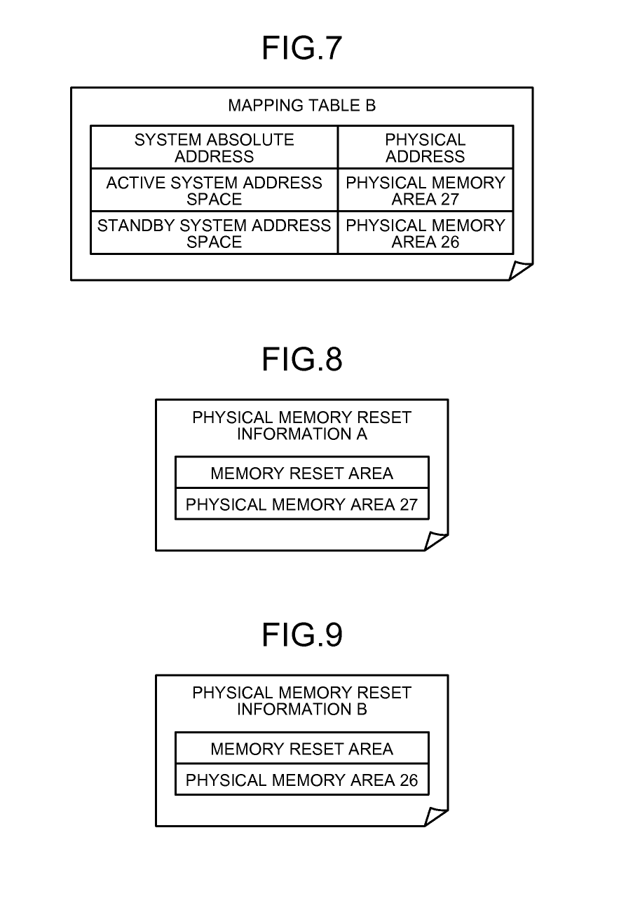

FIG. 7 is a schematic diagram illustrating an example of a mapping table that is set by a management device when the main body device has failed. For example, when the main body device 18 has failed, the management device 11 saves the mapping table A that is set in the main body device 18. Then, the management device 11 swaps the physical addresses that are associated with system absolute addresses in the active system address space and the system absolute addresses in the standby system address space.

Specifically, the management device 11 creates a mapping table B in which the physical memory area 27 is associated with the active system address space in the mapping table A and the physical memory area 26 is associated with the standby system address space. Then, the management device 11 stores the mapping table B in the mapping register 19 in the main body device 18.

FIG. 8 is a schematic diagram illustrating an example of physical memory reset information that is set by the management device when the main body device has failed. For example, when the management device 11 defines the address space that is illustrated in FIG. 6, the management device 11 sets, in the main body device 18 as illustrated in FIG. 8, physical memory reset information A indicating that the physical memory area 27 is reset and then reboots the main body device 18.

Consequently, the main body device 18 clears the physical memory area 27 that is associated with the active system address space and then executes the OS or the application by using the physical memory area 27. Furthermore, because the main body device 18 identifies only the active system address space, the main body device 18 does not access the physical memory area 26 that is associated with the standby system address space. Namely, the main body device 18 reboots itself without clearing the physical memory area 26 that was used before a failure occurred.

Consequently, the management device 11 performs a memory access on the main storage device 25 by using the system absolute addresses in the standby system address space, whereby the management device 11 can dump the data that was used by the main body device 18 before the failure occurred. Consequently, the information processing apparatus 10 reliably performs the dumping process while promptly rebooting the main body device 18.

FIG. 9 is a schematic diagram illustrating physical memory reset information that is set by the management device when the main body device failed again. For example, if the main body device 18 in which the mapping table B is set has failed, the management device 11 saves the mapping table B. Then, the management device 11 creates a mapping table in which the physical memory area associated with the active system address space is swapped with the physical memory area associated with the standby system address space in the mapping table B, i.e., creates the mapping table A, and then stores the created mapping table in the main body device 18.

Furthermore, as illustrated in FIG. 9, the management device 11 creates physical memory reset information B indicating that the physical memory area 26 is used as the memory reset area and then stores the created physical memory reset information B in the memory reset information register 21. Consequently, the main body device 18 clears the physical memory area 26 and then executes the OS or the application by using the physical memory area 26. Then, the management device 11 performs the dumping process on the data stored in the physical memory area 27.

In FIGS. 5 and 7, the management device 11 stores, in the mapping table A and the mapping table B, the system absolute addresses indicated by the active system address space and the system absolute addresses indicated by the standby system address space. However, when the management device 11 performs the initial setting of the main body device 18, the management device 11 only needs to create the mapping table 20 in which the physical addresses is associated with only the system absolute addresses indicated by the active system address space.

Then, when the main body device 18 has failed, the management device 11 only needs to create the mapping table 20 that stores therein the system absolute addresses indicated by the active system address space and the system absolute addresses indicated by the standby system address space.

The mapping register 19 includes a plurality of register groups and stores therein data in which a combination of the system absolute address and the physical address is associated with each of the register groups. At this point, each of the register groups in the mapping register 19 can also change or add the association relationship between an active system address space and a physical memory area by performing, by the OS that is executed by the main body device 18, the rewriting the data.

Consequently, if the management device 11 previously estimates the mapping table A and the mapping table B and swaps data in the mapping table when the main body device 18 has failed, a change or an addition performed by the OS is not updated to the physical memory area that is to be used after the reboot. Thus, the management device 11 temporarily saves the mapping table 20 that is stored in the main body device 18 and then creates, from the saved mapping table 20, the new mapping table 20 that is used after the reboot.

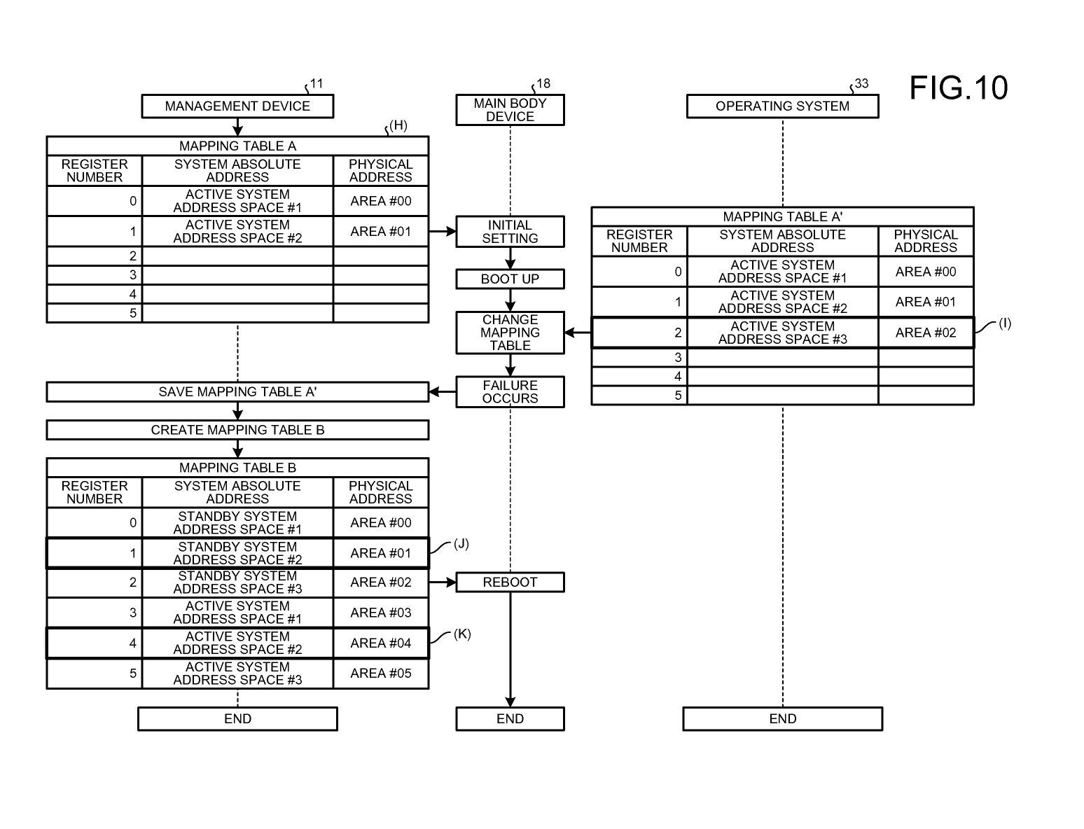

In the following, the flow of a process of creating the new mapping table 20 from the mapping table 20 that is saved by the management device 11 will be described with reference to FIG. 10. FIG. 10 is a schematic diagram illustrating the flow of a process of creating a new mapping table. In the example illustrated in FIG. 10, the mapping register 19 includes six register groups and stores therein, for each register group in an associated manner, the system absolute addresses that indicate the system address space and the physical addresses that indicate the physical memory area.

For example, as indicated by (H) illustrated in FIG. 10, the management device 11 creates the mapping table A by associating the system absolute addresses that indicate the “active system address space #1” with the physical addresses that indicate the “area #00” and by storing the addresses in the register group with the register number of “0”. Furthermore, the management device 11 creates the mapping table A by associating the system absolute addresses that indicate the “active system address space #2” with the physical addresses that indicate the “area #01” and storing the address in the register group with the register number of “1”. Then, the management device 11 sets the created mapping table A, as an initial setting in the mapping register 19, in the main body device 18. Then, the main body device 18 boots up by using the mapping table A.

At this point, as indicated by (I) illustrated in FIG. 10, an operating system 33 executed by the main body device 18 adds the active system address space. Specifically, the operating system 33 associates, in the register group with the register number of “2”, the system absolute addresses that indicate the “active system address space #3” with the “area #02”. Hereinafter, the mapping table in which the association relationship is added by the operating system 33 is referred to as a mapping table A′.

At this point, if a failure occurs in the main body device 18, the management device 11 saves the mapping table A′ and creates a mapping table B by using the saved mapping table A′. Specifically, as indicated by (J) illustrated in FIG. 10, the management device 11 creates the mapping table B in which the “standby system address spaces #1 to #3” are associated with “areas #00 to #02” that are associated with the “active system address spaces #0 to #3”, respectively. Furthermore, as indicated by (K) illustrated in FIG. 10, the management device 11 creates the mapping table B in which “areas #03 to #05”, as new storage areas, are associated with the “active system address spaces #1 to #3”, respectively.

Then, the management device 11 sets the mapping table B in the mapping register 19 and reboots the main body device 18. Consequently, the main body device 18 is rebooted while retaining the active system address space that is set by the operating system 33 before the failure occurred.

When the active system address spaces that are added by the main body device 18 are associated with the standby system address spaces one to one, the number of the active system address spaces is half of the number of physical addresses, i.e., half of all the system absolute address spaces. However, as in a mainframe, if the size of the physical address space to be used is relatively smaller than that of the entirety of the physical address space, no problems occur even if the active system address space is limited to half the number of the physical addresses, i.e., half the size of the entirety of the system absolute address space.

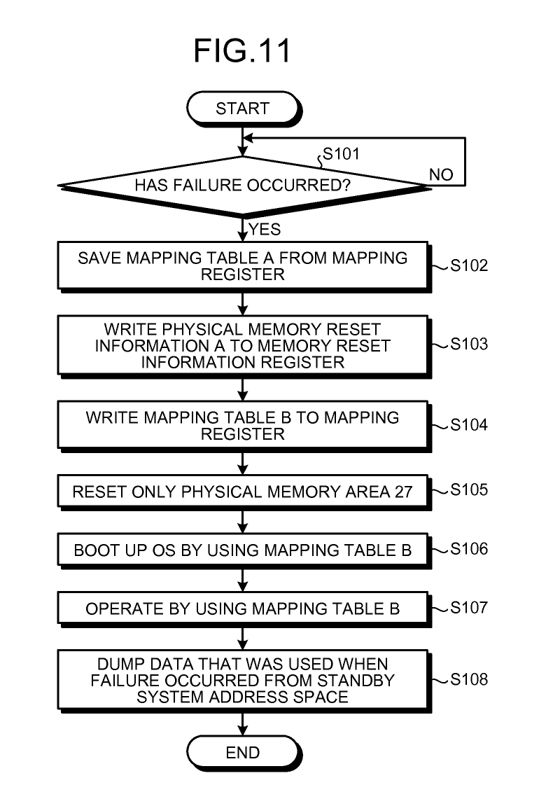

In the following, the flow of the process performed by the information processing apparatus 10 will be described with reference to FIG. 11. FIG. 11 is a flowchart illustrating the flow of a process performed by the information processing apparatus according to the first embodiment. In the example illustrated in FIG. 11, it is assumed that the mapping table A illustrated in FIG. 5 is stored in the mapping register 19 as the mapping table 20.

For example, the management device 11 monitors the state of the main body device 18 by using an arbitrary method and determines whether a failure has occurred (Step S101). If a failure does not occurred (No at Step S101), the management device 11 continues to monitor the main body device 18 and determines whether a failure has occurred (Step S101). In contrast, if a failure has occurred in the main body device 18 (Yes at Step S101), the management device 11 saves the mapping table A from the mapping register 19 (Step S102).

Then, the management device 11 writes the physical memory reset information A illustrated in FIG. 8 to the memory reset information register 21 (Step S103). Then, the management device 11 writes the mapping table B illustrated in FIG. 7 to the mapping register 19 (Step S104). By doing so, the main body device 18 resets only the physical memory area 27 (Step S105) and boots up the OS of the operational system by using the mapping table B (Step S106). Consequently, the main body device 18 starts its operation by using the mapping table B (Step S107). Then, the management device 11 dumps the data that was used when a failure occurred from the physical memory area 26 that is associated with the standby system address space (Step S108) and then ends the process.

### Advantage of the First Embodiment

As described above, the main body device 18 performs a memory access by using the mapping table 20 in which the active system absolute addresses are associated with the physical addresses that indicate the physical memory area 26. In contrast, the management device 11 saves the mapping table 20 when the main body device 18 has failed. Then, the management device 11 creates the new mapping table 20 in which the active system absolute addresses are associated with the physical memory area 27 and the standby system absolute addresses are associated with the physical memory area 26.

Then, the management device 11 stores the new mapping table 20 in the mapping register 19 and then reboots the main body device 18. Furthermore, the management device 11 acquires data from the physical memory area 26 that is associated with the standby system absolute address. Consequently, while promptly rebooting the main body device 18, the management device 11 can dump, at an arbitrary timing, the data that was used when the main body device 18 has failed.

Specifically, the management device 11 stores, in the mapping register 19, the physical addresses that indicate the physical memory area 27 that was not used when the main body device 18 failed, i.e., the mapping table 20 in which the active system absolute addresses are associated with the standby physical addresses. Consequently, the management device 11 can reboot the main body device 18 before the management device 11 dumps the data that was used when the main body device 18 failed.

Furthermore, the management device 11 stores, in the mapping register 19, the mapping table 20 in which the standby system absolute addresses are associated with the physical addresses that indicate the physical memory area 26 that was used when the main body device 18 failed, i.e., the active system physical addresses at the time of the failure. Consequently, even after the main body device 18 is rebooted, the management device 11 can dump the data from the physical memory area 26 without preventing the memory access performed by the OS or the like that is executed by the main body device 18.

The management device 11 is a device independent of the main body device 18. Consequently, even if abnormality occurs in a hypervisor or the OS, the management device 11 can acquire the data that was used by the main body device 18 when a failure occurred from the physical memory area 26. Specifically, when the OS or the HPV executed by the main body device 18 executes the dumping process, if the OS or the HPV is not operated due to a failure of an arithmetic unit or program destruction, information at the time of the occurrence of the failure is not able to be acquired.

However, in the information processing apparatus 10, because the management device 11 dumps the data from the main body device 18, the data used by the main body device 18 when the failure occurs can reliably be dumped regardless of whether the main body device 18 has failed or a reboot of the main body device 18 has been successful. Consequently, the management device 11 can improve the maintainability of the system of the main body device 18.

Furthermore, if the main body device 18 has failed, the management device 11 associates a standby system absolute address with a physical address that is added by the main body device 18 to the mapping table 20. Furthermore, the management device 11 associates a physical address that indicates the physical memory area 27 with an active system absolute address that is added by the main body device 18 to the mapping table 20. Consequently, even when the OS executed by the main body device 18 changes an active system address space, the management device 11 can perform the dumping process while retaining the change and rebooting the main body device 18.

Furthermore, from among all of the system absolute addresses, the management device 11 defines half of the system absolute addresses as the active system absolute addresses. Specifically, the information processing apparatus 10 prepares, in the main storage device 25, a physical memory area the size of which is equal to or greater than twice the active system address space that is indicated by the active system absolute addresses. Then, when the main body device 18 has failed, the management device 11 associates the active system absolute addresses with the physical memory area 27 that was not used by the main body device 18 at the time of the failure. Consequently, the management device 11 can dump the data without performing any change in the OS or the HPV that is executed by the main body device 18 after the main body device 18 is rebooted.

Furthermore, from among all of the system absolute addresses, the management device 11 defines the system absolute addresses at the lower level as the active system absolute addresses and defines the system absolute addresses at the upper level as the standby system absolute addresses. Consequently, the management device 11 can easily change the active system absolute addresses to the standby system absolute addresses. For example, by only inverting the most significant bit of the system absolute address, the management device 11 can swap an active system absolute address with a standby system absolute address.

Furthermore, the management device 11 controls the main body device 18 such that the main body device 18 resets a physical memory area indicated by physical addresses that are associated with active system absolute addresses in the mapping table 20 and reboots by using the reset physical memory area. For example, the management device 11 stores, in the memory reset information register 21, the physical memory reset information 22 that indicates the physical memory area indicated by the physical addresses that is associated with the active system absolute addresses and resets the main body device 18. Consequently, the management device 11 can appropriately reboot the main body device 18.

### [b] Second Embodiment

In the above explanation, a description has been given of the embodiment according to the present invention; however, the embodiment is not limited thereto and can be implemented with various kinds of embodiments other than the embodiment described above. Therefore, another embodiment included in the present invention will be described as a second embodiment below.

(1) Active System Address Space and Standby System Address Space

The management device 11 described above identifies the active system address space and the standby system address space; however, the embodiment is not limited thereto. For example, in addition to the active system address space, the management device 11 identifies a plurality of the standby system address spaces. Then, when the main body device 18 has failed, the management device 11 may also allocate the standby system addresses that have been subjected to the dumping process to the physical memory area that was associated with the active system address space.

(2) Information Processing Apparatus 10

The information processing apparatus 10 described above includes the management device 11 and the main body device 18; however, the embodiment is not limited thereto. For example, the information processing apparatus 10 may also include a plurality of main body devices that perform the same function as that performed by the main body device 18 and one or more management devices 11 may also manage each of the main body devices.

(3) MPU 17

The MPU 17 described above performs the same function as that performed by the saving unit 29, the creating unit 30, the setting unit 31, and the acquiring unit 32 by executing the management program 28; however, the embodiment is not limited thereto. For example, instead of using the MPU 17, various kinds of hardware that perform the same functions as those performed by the saving unit 29, the creating unit 30, the setting unit 31, and the acquiring unit 32 may also be installed in the management device 11.

(4) Active System Address Space that is Added by the Operating System

The operating system 33 executed by the main body device 18 described above increases an active system address space by adding the associated system absolute addresses and the physical addresses to the mapping table 20. At this point, the operating system 33 can increase the active system address space up to the half of the entirety of the system address space.

Furthermore, for example, if the active system address space that is needed to reboot the main body device 18 is equal to or less than the half of the entirety of the system address space, the operating system 33 may also increase the active system address space to the space that is equal to or greater than the half of the entirety of the system address space. Namely, the operating system 33 may also increase the active system address space up to the size in which the standby system address space having the same size as that of the active system address space that is needed to reboot the main body device 18 can be guaranteed.

(5) Program

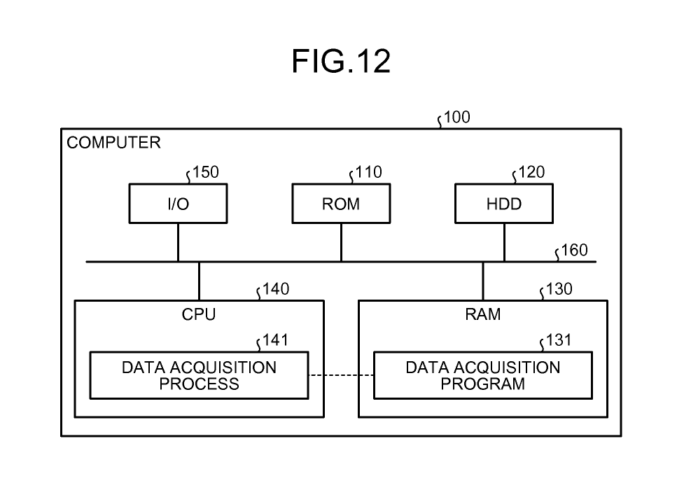

A description has been given of a case in which the management device 11 according to the first embodiment implements the various processes by using the hardware; however, the embodiment is not limited thereto. The embodiment may also be implemented by a program prepared in advance and executed by a computer. Accordingly, in the following, an example of a computer that executes a program having the same function as that performed by the management device 11 described in the first embodiment will be described with reference to FIG. 12. FIG. 12 is a schematic diagram illustrating an example of a computer that executes a data acquisition program.

A computer 100 illustrated in FIG. 12 includes a read only memory (ROM) 110, a hard disk drive (HDD) 120, a random access memory (RAM) 130, and a central processing unit (CPU) 140, which are connected by a bus 160. Furthermore, the computer 100 illustrated as an example in FIG. 12 includes an input/output (I/O) 150 that is used to connect the units to the main body device 18.

The RAM 130 stores therein, in advance, a data acquisition program 131. The CPU 140 reads the data acquisition program 131 from the RAM 130 and executes the program so that, in the example illustrated in FIG. 12, the data acquisition program 131 functions as a data acquisition process 141. The data acquisition process 141 executes the same process as that performed by the MPU 17 illustrated in FIG. 1.

Furthermore, the management program 28 and the data acquisition program 131 described in the embodiment can be implemented by programs prepared in advance and executed by a computer, such as a personal computer or a workstation. The program can be distributed via a network, such as the Internet.

Furthermore, the management program 28 and the data acquisition program 131 are stored in a computer-readable recording medium, such as a hard disk, a flexible disk (FD), a compact disc read only memory (CD-ROM), a magneto optical disc (MO), a digital versatile disc (DVD), or the like. Furthermore, the management program 28 and the data acquisition program 131 may also be executed by a computer reading the programs from the recording medium.

Furthermore, the management program 28 and the data acquisition program 131 may also function not only as application programs but also as part of the functions included in the OS or as part of firmware.

According to an aspect of an embodiment, an advantage is provided in that data that is used when a failure occurs can be dumped while a system is promptly rebooted.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management device comprising:
a processor that executes a process including:
saving a conversion table when an information processing apparatus that performs a memory access by using the conversion table, in which an active absolute address that is used by the processor to specify data is associated with an active physical address that indicates a storage area in a memory that stores therein the data, has failed;
creating, by using the conversion table saved at the saving, a second conversion table in which a standby absolute address that is different from the active absolute address is associated with the active physical address used at the time of a failure and a standby physical address that is different from the active physical address used at the time of the failure is associated with the active absolute address;
setting, in the information processing apparatus, the second conversion table created at the creating; and
acquiring, by using the second conversion table that is set at the setting, the data from the storage area that is indicated by the physical address associated with the standby absolute address.

2. The management device according to claim 1, wherein
when a new storage area to be used is added, the information processing apparatus associates a new absolute address with the physical address that indicates the new storage area and adds the associated address in the conversion table, and
the creating includes creating the second conversion table in which the standby physical address used at the time of a failure is associated with the active absolute address and the absolute address that is added by the information processing apparatus and in which the standby absolute address is associated with the active physical address used at the time of the failure and the physical address that is added by the information processing apparatus.

3. The management device according to claim 1, wherein, when the information processing apparatus is booted up, the setting includes setting, in the information processing apparatus, a conversion table in which absolute addresses the number of which is half or less of all of the absolute addresses that are possible to set are defined as the active absolute addresses.

4. The management device according to claim 3, wherein the setting includes defining, from among all of the absolute addresses that are possible to set, absolute addresses at a lower level as the active absolute addresses and defining, from among all of the absolute addresses that are possible to set, absolute addresses at an upper level as the standby absolute addresses.

5. The management device according to claim 1, wherein the process further includes resetting the storage area that is indicated by the physical address associated with the active absolute address included in the second conversion table that is set at the setting and controlling the information processing apparatus such that a reboot is performed by using the reset storage area.

6. A data acquisition method:
managing an information processing apparatus that performs a memory access by using a conversion table in which an absolute address that is used by an processor to specify data is associated with a physical address that indicates a storage area in a memory, by the processor;
saving, when the information processing apparatus has failed, the conversion table, by the processor;
creating, by using the saved conversion table, a second conversion table in which a standby absolute address that is different from the active absolute address is associated with the active physical address used at the time of a failure and a standby physical address that is different from the active physical address used at the time of the failure is associated with the active absolute address, by the processor;
setting the created second conversion table in the information processing apparatus, by the processor; and
acquiring, by using the set second conversion table, the data from the storage area that is indicated by the physical address associated with the standby absolute address, by the processor.

7. A non-transitory computer-readable recording medium having stored therein a program that causes a computer to execute a data acquisition process comprising:
saving, when an information processing apparatus that performs a memory access by using a conversion table in which an absolute address that is used by an processor to specify data is associated with a physical address that indicates a storage area in a memory has failed, the conversion table;
creating, by using the saved conversion table, a second conversion table in which a standby absolute address that is different from the active absolute address is associated with the active physical address used at the time of a failure and a standby physical address that is different from the active physical address used at the time of the failure is associated with the active absolute address;
setting the created second conversion table in the information processing apparatus; and
acquiring, by using the set second conversion table, the data from the storage area that is indicated by the physical address associated with the standby absolute address.
